(19) United States
(12) Patent Application Publication
(10) Pub. No.: US 2025/0229332 A1
(43) Pub. Date: Jul. 17, 2025

(54) MANUFACTURING DEVICE AND METHOD FOR THE ADDITIVE MANUFACTURING OF COMPONENTS FROM A POWDER MATERIAL AND METHOD FOR DETERMINING A CORRECTION FUNCTION FOR A MANUFACTURING DEVICE OF THIS TYPE OR A METHOD OF THIS TYPE

(71) Applicant: TRUMPF Laser- und Systemtechnik SE, Ditzingen (DE)

(72) Inventors: Matthias Allenberg-Rabe, Ludwigsburg (DE); Daniel Coupek, Weissach (DE)

(21) Appl. No.: 19/058,042

(22) Filed: Feb. 20, 2025

Related U.S. Application Data
(63) Continuation of application No. PCT/EP2023/072138, filed on Aug. 10, 2023.

(30) Foreign Application Priority Data
Aug. 23, 2022 (DE) 10 2022 121 238.6

(51) Int. Cl. B22F 10/36; B22F 10/28; B22F 12/40; B33Y 10/00; B33Y 30/00; B33Y 50/02

(52) U.S. Cl. CPC B22F 10/36; B22F 10/28; B22F 12/40; B33Y 10/00; B33Y 30/00; B33Y 50/02

(57) ABSTRACT

A manufacturing device for additive manufacturing of components from a powder material includes a beam-generating device configured to generate an energy beam having a beam profile that is not rotationally symmetrical about a beam axis of the energy beam, a beam-rotating device configured to rotate the beam profile of the energy beam about the beam axis, a scanner device configured to move the energy beam in a working region and to locally selectively irradiate the working region with the energy beam in order to produce, by the energy beam, a component from the powder material located in the working region, and a control device operatively connected to the beam-rotating device and to the scanner device, and configured to control the beam-rotating device and the scanner device. The control device is configured to correct a control of the scanner device according to a current angle of rotation of the beam-rotating device.

### CROSS REFERENCE TO RELATED APPLICATIONS

This application is a continuation of International Application No. PCT/EP2023/072138 (WO 2024/041899 A1), filed on Aug. 10, 2023, and claims benefit to German Patent Application No. DE 10 2022 121 238.6, filed on Aug. 23, 2022. The aforementioned applications are hereby incorporated by reference herein.

### FIELD

Embodiments of the present invention relate to a manufacturing device and a method for the additive manufacturing of components from a powder material, and a method for determining a correction function for the angle of rotation-dependent control of a scanner device in such a manufacturing device, or for the angle of rotation-dependent control of beam positions in such a method.

### BACKGROUND

For the additive manufacturing of components from a powder material, it can be expedient to use an energy beam that has a beam profile that is not rotationally symmetrical about its beam axis. Depending on the direction of movement of the beam profile on a working region of a manufacturing device, in particular depending on the orientation of a respective irradiation vector, it is then further expedient or necessary to be able to rotate the beam profile and thus align it relative to the irradiation vector. In particular, a longer axis of two orthogonal axes of the beam profile can be aligned in the direction of the irradiation vector. The problem here is that manufacturing tolerances of a beam-generating device for generating the energy beam as well as even small adjustment errors of the beam axis in a beam-rotating device intended for rotating the beam profile lead to an undesirable faltering of the beam profile, in particular to an undesirable movement of a center of gravity of the beam profile, during its rotation. This can result in defects in the component to be manufactured, particularly at locations in the working region where the orientation of neighboring irradiation vectors changes, wherein this can lead in particular to rough component surfaces, dimensional deviations and a locally reduced component density.

Obvious ways to solve this problem would be an extremely precise adjustment of the energy beam and/or an extremely low-tolerance manufacturing of the beam-generating device. However, both are excessively complex and expensive and therefore hardly feasible in practice. In particular, the energy beam would always have to be readjusted with maximum accuracy if the manufacturing device had been moved or exposed to vibrations in any other way.

### SUMMARY

Embodiments of the present invention provide a manufacturing device for additive manufacturing of components from a powder material. The manufacturing device includes a beam-generating device configured to generate an energy beam having a beam profile that is not rotationally symmetrical about a beam axis of the energy beam, a beam-rotating device configured to rotate the beam profile of the energy beam about the beam axis, a scanner device configured to move the energy beam in a working region and to locally selectively irradiate the working region with the energy beam in order to produce, by the energy beam, a component from the powder material located in the working region, and a control device operatively connected to the beam-rotating device and to the scanner device, and configured to control the beam-rotating device and the scanner device. The control device is configured to correct a control of the scanner device according to a current angle of rotation of the beam-rotating device.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic representation of an exemplary embodiment of a manufacturing device; and

FIG. 2a and FIG. 2b show a schematic representation of an exemplary embodiment of a method for determining a correction function for the angle of rotation-dependent control of a scanner device of the manufacturing device.

### DETAILED DESCRIPTION

Embodiments of the present invention provide a manufacturing device and a method for the additive manufacturing of components from a powder material and a method for determining a correction function for the angle of rotation-dependent control of a scanner device in such a manufacturing device, or for the angle of rotation-dependent control of beam positions in such a method, whereby the disadvantages mentioned are at least reduced and preferably do not occur.

Embodiments of the present invention provide a manufacturing device for additive manufacturing of components from a powder material, having a beam-generating device, wherein the beam-generating device is designed to generate an energy beam with a beam profile that is not rotationally symmetrical about a beam axis of the energy beam. The manufacturing device also has a beam-rotating device, which is designed to rotate the beam profile of the energy beam about the beam axis. Furthermore, the manufacturing device has a scanner device, which is designed to move the energy beam in a working region and to locally selectively irradiate the working region with the energy beam in order to produce, by means of the energy beam, a component from the powder material located in the working region. Furthermore, the manufacturing device has a control device which is operatively connected to the beam-rotating device and to the scanner device and is designed to control the beam-rotating device and the scanner device, and to correct control of the scanner device according to a current angle of rotation of the beam-rotating device. Advantageously, the correction of the control of the scanner device can be used to correct a wobbling movement that occurs due to a rotation of the beam profile, in particular by moving the center of gravity of the beam profile to a predetermined target location on the working region by means of suitable angle of rotation-dependent correction of the control of the scanner device—due to the correction independent of the rotation angle. In particular, this results in a defined connection between areas of irradiation vectors with a first orientation and adjacent regions of irradiation vectors with a second, different orientation in the working region. In this way, defects in the component to be manufactured, in particular rough component surfaces, dimensional deviations or a locally reduced component density, can be advantageously avoided. The correction itself can be carried out easily and cost-effectively, in particular using software, so that neither extremely precise manufacturing of the beam-generating device nor extremely precise adjustment of the energy beam is required.

In particular, a coordinate system in the working region is spanned by two Cartesian coordinates, in particular an x-coordinate and a y-coordinate, wherein the angle of rotation-dependent correction comprises a first correction contribution for the x-coordinate and a second correction contribution for the y-coordinate. The control of the scanner device is therefore corrected in particular dependent on the angle of rotation in the x-direction and y-direction of the working region. In particular, an angle of rotation-dependent deviation of an actual profile position from a target profile position of the beam profile in the x-direction and y-direction is corrected.

In the context of the present technical teaching, a center of gravity of the beam profile is understood to mean in particular a point that is selected from a group consisting of: a center of gravity of an intensity distribution of the beam profile on the working region, in particular a center of the beam profile weighted with the local intensities, a location of a maximum of the intensity distribution, and a geometric center of the beam profile.

In one embodiment, the control of the scanner device is additionally corrected according to the current control itself. This means in particular that the angle of rotation-dependent correction is in turn dependent on the current location of the beam profile on the working region. In this way, distortions, in particular in edge regions remote from a center of the working region, can be advantageously reduced, preferably avoided.

Additive or generative manufacturing or production of a component is understood to mean in particular a powder bed-based process for producing a component, in particular a manufacturing method selected from a group consisting of selective laser sintering, laser metal fusion (LMF), direct metal laser melting (DMLM), laser net shaping manufacturing (LNSM), (selective) electron beam melting ((S) EBM), and laser engineered net shaping (LENS). Accordingly, the manufacturing device is designed in particular to perform at least one of the above-mentioned additive or generative manufacturing methods.

The energy beam is in particular selected from a group consisting of an electromagnetic beam, in particular an optical working beam, in particular a laser beam, and a particle beam, in particular an electron beam. The energy beam can be continuous or pulsed, in particular continuous laser radiation or pulsed laser radiation.

In one embodiment, the beam-generating device is designed to generate a plurality of energy beams and/or the manufacturing device comprises a plurality of beam-generating devices for generating a plurality of energy beams. It is possible that a plurality of scanner devices are provided for the plurality of energy beams. However, it is also possible that the scanner device is designed to move a plurality of energy beams—in particular independently of one another—on the working region. In particular, the scanner device can comprise a plurality of separately controllable scanners for this purpose, in particular scanner mirrors.

In particular, the control device is designed to correct the control of the scanner device, in particular the control of the respectively assigned scanner, for each energy beam of the plurality of energy beams according to the respective angle of rotation. Alternatively or additionally, the control device is designed to coordinate or additionally correct the control of the scanner device for the plurality of energy beams, in particular for each energy beam of the plurality of energy beams, in such a way that identical points on the working region can be controlled with each of the energy beams; in particular, the control device is thus designed to register or calibrate the control of the scanner device for the plurality of energy beams relative to one another. In one embodiment, this takes place after the angle of rotation-dependent correction of the control, so that the angle of rotation-dependent corrected beam positions are registered or calibrated relative to one another. In another embodiment, however, a different order is also possible.

The scanner device preferably comprises at least one scanner, in particular a galvanometer scanner, a piezo scanner, a polygon scanner, an MEMS scanner, and/or a working head or processing head movable relative to the working region. The scanner devices proposed here are especially suitable for moving the energy beam between a plurality of beam positions within the working region.

A working head or processing head which is movable relative to the working region is understood here to mean in particular an integrated component of the manufacturing device which has at least one radiation outlet for at least one energy beam, wherein the integrated component, that is to say the working head, is movable as a whole along at least one direction of movement, preferably along two mutually perpendicular directions of movement, relative to the working region. Such a working head can in particular be designed as a gantry or be guided by a robot. The working head may in particular be designed as a robot hand of a robot.

The control device is preferably selected from a group consisting of a computer, in particular a personal computer (PC), a plug-in card or controller card, and an FPGA board.

Preferably, the beam-generating device comprises a laser. The energy beam is thus advantageously produced as an intensive beam of coherent electromagnetic radiation, in particular coherent light. In this respect, irradiation preferably means laser exposure.

The beam-generating device can in particular comprise prisms for generating the non-rotationally symmetrical beam profile, preferably in particular at least one anamorphic prism, in particular an anamorphic prism pair, and/or a Dove prism, or a prism pair consisting of an anamorphic prism and an anamorphic Dove prism. The beam-rotating device can in particular be designed to rotate at least one prism of the beam-generating device, preferably the anamorphic prism pair, or the Dove prism, or the prism pair consisting of the anamorphic prism and the anamorphic Dove prism, about the beam axis. Alternatively or additionally, the beam-generating device for generating the non-rotationally symmetrical beam profile can comprise at least one diffractive optical element (DOE), in particular a plurality of diffractive optical elements. The beam-rotating device can in particular be designed to rotate at least one diffractive optical element of the beam-generating device about the beam axis.

The manufacturing device is preferably designed for selective laser sintering. As an alternative or in addition, the manufacturing device is designed for selective laser melting. These embodiments of the manufacturing device have proven to be particularly advantageous.

An irradiation vector is understood in particular as a continuous, preferably linear movement of the energy beam over a specific distance with a specific direction of movement. The irradiation vector includes in particular the direction or orientation of the movement, i.e., the vector orientation. The irradiation vector does not have to be a straight line, but rather an irradiation vector can also follow a line or curve that is at least partially curved.

According to a further embodiment of the invention, it is provided that the control device is designed to use a correction function dependent on the angle of rotation of the beam-rotating device for correcting the control of the scanner device. This represents a simple, functional and precise way of correcting the control.

In one embodiment, the correction function is a correction curve in the form of supporting points, in particular including an interpolation between the supporting points. In another embodiment, the correction function is an analytical function. In another embodiment, the correction function is a table or assignment, in particular a lookup table or conversion table, which comprises correction values for the control according to the current angle of rotation.

In one embodiment, the correction function additionally depends on the control of the scanner device itself. In this way in particular, distortions, in particular in edge regions remote from a center of the working region, can be advantageously reduced, preferably avoided.

According to a further embodiment of the invention, it is provided that a function is used as the correction function which additionally depends on a history of the control of the beam-rotating device. In this way, in particular a hysteresis in the angle of rotation-dependent wobble behavior of the beam profile, which is caused, for example, by the mechanics of the beam-rotating device, in particular by play in the mechanics, can be advantageously compensated for.

Alternatively or additionally, a function is used as the correction function which additionally depends on a direction of rotation of the beam-rotating device. This is a particularly suitable option for compensating for the hysteresis in the angle of rotation-dependent wobble behavior of the beam profile.

Alternatively, a function averaged over both directions of rotation of the beam-rotating device is used as the correction function. This is a particularly simple and less computationally intensive option for at least approximately compensating for the hysteresis in the angle of rotation-dependent wobble behavior of the beam profile.

According to a further embodiment of the invention, it is provided that the beam-rotating device is designed to rotate the beam profile only in exactly one predetermined direction of rotation. In this way, hysteresis in the angle of rotation-dependent wobble behavior of the beam profile is advantageously avoided, so that no compensation is required. Therefore, this embodiment is particularly simple. In particular, in this case, however, the beam-rotating device is designed to effect an endless rotation or unlimited rotation of the beam profile—in particular without a stop—in the predetermined direction of rotation, so that in particular any angle of rotation can be achieved at any time.

The object is also achieved by creating a method, also known as a manufacturing method, for the additive manufacturing of components from a powder material, wherein an angle of rotation of a beam profile which is not rotationally symmetrical about a beam axis of an energy beam is set around the beam axis, wherein the energy beam is moved to a plurality of beam positions in a working region, so that the working region is locally selectively irradiated with the energy beam at the beam positions in order to produce, by means of the energy beam, a component from the powder material located in the working region, and wherein a correction of the control of the beam positions takes place according to the set angle of rotation. In particular, the advantages that have already been described in connection with the manufacturing device arise in connection with the manufacturing method.

The fact that the angle of rotation of the beam profile is adjusted means in particular that the angle of rotation—during the manufacturing method—is changed.

A laser beam or an electron beam is preferably used as the energy beam.

The component is preferably manufactured by way of selective laser sintering and/or selective laser melting.

A metal or ceramic powder in particular can preferably be used as powder material.

According to a further embodiment of the invention, it is provided that a correction vector is assigned to the beam positions according to the set angle of rotation.

In one embodiment, each beam position is assigned the same angle of rotation-dependent correction vector according to the set angle of rotation. In another embodiment, the correction vector is dependent on the beam position in addition to the dependence on the angle of rotation. In particular, distortions, in particular in the edge regions of the working region, can be reduced, and preferably avoided, in this way.

In particular, the correction vector is assigned to the beam positions according to the set angle of rotation using a correction function. In one embodiment, the correction function is a correction curve in the form of supporting points, in particular including an interpolation between the supporting points. In another embodiment, the correction function is an analytical function. In another embodiment, the correction function is a table or assignment, which comprises correction values for the control according to the current angle of rotation.

The object is finally also achieved by a method, also referred to as a determination method, for determining a correction function for the angle of rotation-dependent control of a scanner device in a manufacturing device according to embodiments of the invention or a manufacturing device according to one or more of the embodiments described above, or for the angle of rotation-dependent control of beam positions in a process according to embodiments of the invention or a manufacturing method according to one or more of the embodiments described above, wherein a deviation of an actual profile position, in particular the main focus, of the beam profile from a target profile position, in particular the main focus, of the beam profile on the working region is determined, which deviation being dependent on an angle of rotation of a beam-rotating device designed to rotate a beam profile of the energy beam about the beam axis, which beam profile being not rotationally symmetrical about a beam axis of an energy beam, and wherein the correction function is determined based on the determined angle of rotation-dependent deviation. In particular, the advantages that have already been described in connection with the manufacturing device or the manufacturing method arise in connection with the determination method.

According to a further embodiment of the invention, it is provided that a fixed beam position for the energy beam is specified for a scanner device of a manufacturing device, which determines the target profile position of the beam profile on the working region, wherein the beam profile is rotated around the beam axis at the fixed beam position by means of the beam-rotating device, and wherein the actual profile position of the beam profile on the working region is determined according to the angle of rotation of the beam-rotating device.

In one embodiment, this is carried out at exactly one fixed beam position—in particular in the middle or centrally on the working region, wherein the correction function obtained on the basis of the angle of angle of rotation-dependent deviations of the actual profile positions from the target profile position determined at the fixed beam position is used for all beam positions on the working region. In another embodiment, the determination method is carried out at a plurality of fixed beam positions on the working region, wherein the correction function is additionally obtained according to the respective beam position, or wherein different correction functions are obtained for different beam positions.

According to a further embodiment of the invention, it is provided that the actual profile position of the beam profile is determined by means of a sensor device located in the working region. This represents a particularly precise and at the same time simple design of the determination method, in particular since the respective actual profile position can be determined directly by the sensor device located in the working region. In particular, the respective actual profile position is directly identical to the respective position of the beam profile on the sensor device.

In another embodiment, it is also possible for the actual profile position on the working region to be detected by a sensor device located outside the working region and aligned with the working region, for example a powder bed camera.

In one embodiment, the sensor device is designed as a camera. In another embodiment, the sensor device can be designed as a substrate plate that can be arranged in the working region and has a plurality of light-sensitive cells, in particular photodiodes, located on or at the substrate plate or integrated into the substrate plate.

According to a further embodiment of the invention, it is provided that, before a first determination of the actual profile position, a relative position is determined between a machine coordinate system of the manufacturing device predetermined by the scanner device and a sensor coordinate system of the sensor device—located in particular in the working region. In this way, the actual profile position in particular can advantageously be detected directly in the machine coordinate system by the sensor device, or the actual profile position in the machine coordinate system can be easily calculated from the actual profile position detected in the sensor coordinate system. In any case, this makes it possible to carry out a highly precise correction of the angle of rotation-dependent deviation of the actual profile position from the target profile position.

In particular, in one embodiment, a transformation between the sensor coordinate system and the machine coordinate system is determined, and the transformation is taken into account or applied when determining the actual profile position, so that the actual profile position is determined directly in the machine coordinate system or can be calculated back to its position in the machine coordinate system.

Alternatively or additionally, it is possible for the relative position between the machine coordinate system and the sensor coordinate system to be corrected, in particular by suitably aligning the sensor device relative to the manufacturing device. In this way, in the optimal case, the sensor coordinate system can be brought into line with the machine coordinate system, or at least a deviation between the sensor coordinate system and the machine coordinate system can be minimized.

In one embodiment of the determination method, the actual profile position is first recorded by means of the sensor device over a predetermined measuring time at the fixed beam position without rotating the beam profile. In particular, measurement noise of the sensor device is determined in this way. Preferably, a filter is generated based on the determined measurement noise, with which the subsequently detected signals of the sensor device are filtered. This has the advantage of obtaining a very low-noise signal.

Subsequently, the relative position between the machine coordinate system and the sensor coordinate system is preferably determined, in particular by deflecting the energy beam on the working region in the positive and negative x-direction and also in the positive and negative y-direction, in particular in such a way that an axis cross is imaged in the sensor device. From this, a translation and rotation between the machine coordinate system and the sensor coordinate system can then be calculated and, in particular, compensated for.

Then, the beam profile is preferably rotated continuously by means of the beam-rotating device, in particular at a constant rotational speed, wherein in particular the actual profile position of the beam profile is recorded at a predetermined, constant measuring frequency. The lower the rotational speed or the higher the measurement frequency, the higher the number of measurement points recorded. Alternatively, it is possible to approach individual angles of rotation in a targeted manner, whereby the respective actual profile position is recorded in a stationary manner.

According to a further embodiment of the invention, it is provided that the correction function is obtained by interpolation of the angle of rotation-dependent deviation. In particular, the correction function is obtained in this way as a correction curve in the form of supporting points including the interpolation between the supporting points. This represents a particularly simple and preferably, at the same time, accurate embodiment of the method, especially if a sufficient number of supporting points are used. In particular, this design of the method enables—depending on the interpolation used—a simple calculation of the correction function.

Alternatively, it is provided that the correction function is obtained by adapting an analytical function to the angle of rotation-dependent deviation, wherein the correction function is obtained as the adapted analytical function. Advantageously, an analytical correction can be calculated in this way for any angle of rotation, which is particularly more accurate the more complex the analytical function is. Another advantage of this embodiment of the method is that the required memory is low, since only one formula is stored instead of supporting points.

Alternatively, it is provided that the angle of rotation-dependent deviation itself is retained as the correction function. In particular, in this way the correction function is obtained as a table or assignment, which comprises correction values for the control according to the current angle of rotation. This represents a particularly simple and computationally inexpensive design of the method.

According to a further embodiment of the invention, it is provided that a separate angle of rotation-dependent deviation is determined for each direction of rotation of the beam-rotating device. In particular, a hysteresis in the wobble behavior of the beam profile can be compensated for in this way.

Alternatively, it is provided that the beam-rotating device is rotated exclusively in a specific direction of rotation to determine the angle of rotation-dependent deviation. In particular, this avoids hysteresis in the wobble behavior of the beam profile, so that no compensation of the hysteresis is required.

According to a further embodiment of the invention, it is provided that a first angle of rotation-dependent deviation is determined for a first direction of rotation of the beam-rotating device, wherein a second angle of rotation-dependent deviation is determined for a second direction of rotation of the beam-rotating device which is different from the first direction of rotation, and wherein the correction function is obtained by averaging the first angle of rotation-dependent deviation and the second angle of rotation-dependent deviation. This represents a comparatively simple way of compensating for hysteresis.

Alternatively, as the correction function, a first correction function assigned to the first direction of rotation is obtained based on the first angle of rotation-dependent deviation, and a second correction function assigned to the second direction of rotation is obtained based on the second angle of rotation-dependent deviation. This represents a particularly precise way of compensating for hysteresis.

Embodiments of the invention will be explained in more detail below with the aid of the drawing.

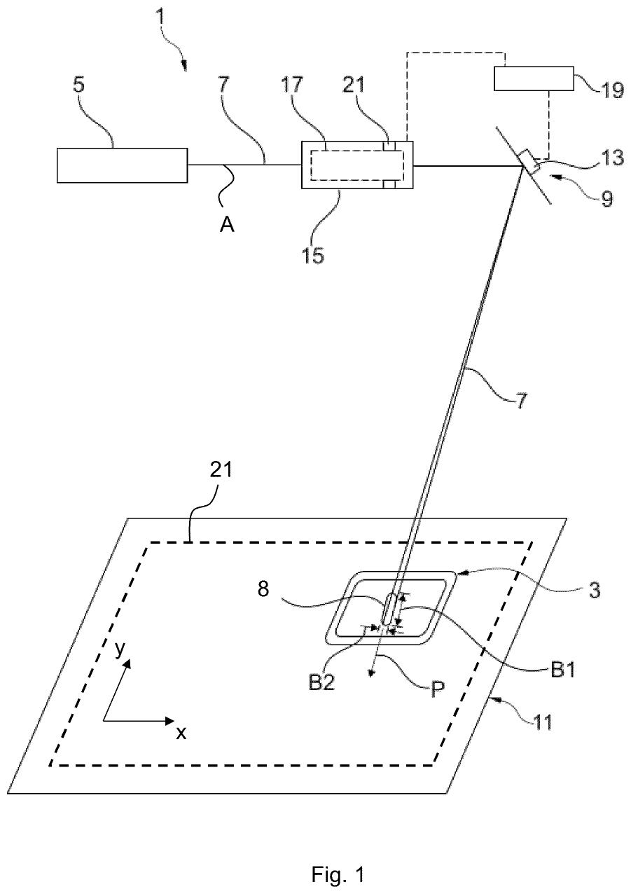

FIG. 1 shows a schematic representation of an exemplary embodiment of a manufacturing device 1 for the additive manufacturing of components 3 from a powder material.

The manufacturing device 1 has a beam-generating device 5, which is designed to generate an energy beam 7 having a beam profile 8 which is not rotationally symmetrical about a beam axis A of the energy beam 7, in particular with a first, larger width B1 along a y-direction on a working region 11 of the manufacturing device 1 and with a second, smaller width B2 along an x-direction on the working region 11. The manufacturing device 1 also has a beam-rotating device 15, which is designed to rotate the beam profile 8 of the energy beam 7 about the beam axis A. For this purpose, the beam-rotating device 15 preferably has an optical unit 17 which is rotatably mounted in a pivot bearing 21 and which can comprise, for example, a Dove prism or an anamorphic Dove prism. Furthermore, the manufacturing device 1 has a scanner device 9, which is designed to move the energy beam 7—in particular by means of a scanner 13—in a working region 11 and to locally selectively irradiate the working region 11 with the energy beam 7 in order to produce, by means of the energy beam 7, a component 3 from the powder material located in the working region 11. In particular, an arrow P indicates an irradiation vector, in the direction of which the beam profile 8 is moved by means of the scanner device 9. The working region 11 is exposed to a plurality of such irradiation vectors during the manufacture of the component 3, wherein the irradiation vectors have in particular different orientations. The beam-rotating device 15 serves in particular to align the beam profile 8 relative to a respective orientation of the respective irradiation vector. The manufacturing device 1 also has a control device 19 which is operatively connected to the beam-rotating device 15 and to the scanner device 9 and is designed to control the beam-rotating device 15 and the scanner device 9, wherein the control device 19 is designed to correct control of the scanner device 9 according to a current angle of rotation of the beam-rotating device 15.

In particular, if the beam axis A is not aligned completely precisely relative to an axis of rotation of the beam-rotating device 15, a rotation of the beam profile 8 results in a movement of the beam profile on the scanner 13 and thus, as a result, an undesirable wobbling movement of a focus of the beam profile 8 on the working region 11. This wobbling movement can advantageously be compensated for at least largely, and possibly completely, by the angle of rotation-dependent correction of the control of the scanner device 9. For this purpose, the control of the scanner device 9 is preferably corrected both in the x-direction and in the y-direction in such a way that the focus of the beam profile 8—when the uncorrected control of the scanner device 9 is fixed—always comes to lie on the same point on the working region 11 as specified by the uncorrected control of the scanner device 9 due to the correction, regardless of the angle of rotation.

The control device 19 is preferably designed to use a correction function dependent on the angle of rotation of the beam-rotating device 15 for correcting the control of the scanner device 9.

In particular, a function is used as the correction function, which additionally depends on a history of the control of the beam-rotating device 15 and/or on a direction of rotation of the beam-rotating device 15. Alternatively, a function averaged over both directions of rotation of the beam-rotating device 15 is used as the correction function.

Alternatively, the beam-rotating device 15 is designed to rotate the beam profile 8 only in a predetermined direction of rotation, wherein in particular an endless rotation in the predetermined direction of rotation is possible.

As part of a method, also known as a manufacturing method, for the additive manufacturing of a component 3 from the powder material, an angle of rotation of the beam profile 8 about the beam axis A is adjusted, in particular changed, wherein the energy beam 7 is moved to a plurality of beam positions in a working region 11, so that the working region 11 is locally selectively irradiated with the energy beam 7 at the beam positions in order to produce, by means of the energy beam 7, the component 3 from the powder material located in the working region 11. A correction of the control of the beam positions is carried out according to the set angle of rotation.

In particular, a correction vector, in particular based on a correction function, is assigned to the beam positions according to the set angle of rotation.

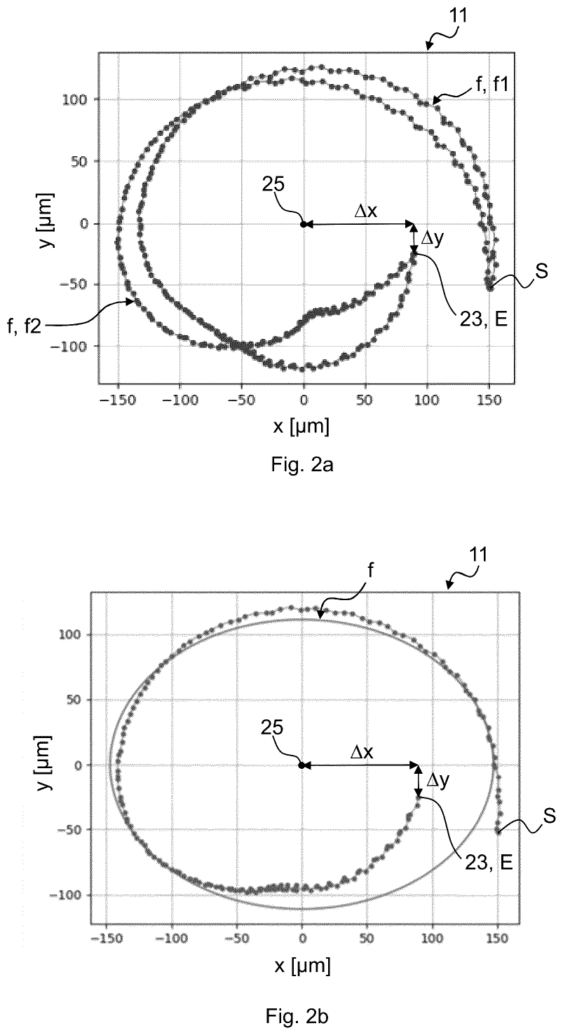

FIG. 2 shows a schematic representation of an exemplary embodiment of a method, also known as a determination method, for determining a correction function f for the angle of rotation-dependent control of the scanner device 9 of the manufacturing device 1.

Elements that are the same or functionally equivalent are provided with the same references in all the figures, so that in this regard reference is respectively made to the preceding description.

As part of the determination method, a deviation of an actual profile position 23, in particular of a center of gravity of the beam profile 8, from a target profile position 25 of the center of gravity of the beam profile 8 on the working region 11, which is dependent on the angle of rotation of the beam profile 8 about the beam axis A, is determined, wherein the correction function f is determined based on the determined angle of rotation-dependent deviation. For the sake of clarity, only one actual profile position 23 is marked with the corresponding reference symbol in FIG. 2. In particular, the deviation is determined as a deviation vector with a first deviation component Dx along the x-coordinate and a second deviation component Dy is determined along the y-coordinate on the working region 11.

In particular, a fixed beam position for the energy beam 7 is specified for the scanner device 9, which determines the target profile position 25 of the beam profile 8 on the working region 11—here at the origin of the machine coordinate system shown at x=0 and y=0. The beam profile 8 is rotated around the beam axis A at the fixed beam position by means of the beam-rotating device 15, wherein the actual profile position 23 of the beam profile 8 on the working region 11 is determined according to the angle of rotation of the beam-rotating device 9.

In particular, the actual profile position 23 of the beam profile 8 is determined by means of a sensor device 21 located in the working region 11 and indicated schematically in FIG. 1.

Preferably, before a first determination of the actual profile position 23, a relative position is determined between a machine coordinate system of the manufacturing device 1 predetermined by the scanner device 9 and a sensor coordinate system of the sensor device 21, such that the determination of the actual profile position 23 can then take place directly in the machine coordinate system.

In a), a first embodiment of the determination method is shown, in which the correction function f is obtained by interpolation of the angle of rotation-dependent deviations.

At the same time, the design described in a) provides that—in particular for the purpose of hysteresis compensation—a separate angle of rotation-dependent deviation is determined for each direction of rotation of the beam-rotating device 15, wherein a first angle of rotation-dependent deviation is determined in particular for a first direction of rotation of the beam-rotating device 15—in particular starting from the point marked S by a full 360° counterclockwise up to the point marked E, wherein a second angle of rotation-dependent deviation is determined for a second direction of rotation of the beam-rotating device 15 being different to the first angle of rotation—in particular, backwards, starting from the point marked E by a full 360° counterclockwise up to the point marked S, and wherein, as the correction function f, a first correction function f1 assigned to the first direction of rotation is obtained based on the first angle of rotation-dependent deviation, and a second correction function f2 assigned to the second direction of rotation is obtained based on the second angle of rotation-dependent deviation.

Alternatively, it is possible that the beam-rotating device 15 is rotated exclusively in a specific direction of rotation to determine the angle of rotation-dependent deviation, such that only a correction function f is obtained and no hysteresis compensation is required.

In b), a second embodiment of the determination method is shown, in which the correction function f is obtained by adapting an analytical function, in this case an ellipse, to the angle of rotation-dependent deviation, wherein the correction function f is obtained as the adapted analytical function.

At the same time, in the embodiment shown in b), it is provided that an averaging of the first angle of rotation-dependent deviation and the second angle of rotation-dependent deviation is used to determine the correction function f. In particular, b) shows an averaged curve from the first and second angle of rotation-dependent deviations shown in a).

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A manufacturing device for additive manufacturing of components from a powder material, the manufacturing device comprising:
a beam-generating device configured to generate an energy beam having a beam profile that is not rotationally symmetrical about a beam axis of the energy beam,
a beam-rotating device configured to rotate the beam profile of the energy beam about the beam axis,
a scanner device configured to move the energy beam in a working region and to locally selectively irradiate the working region with the energy beam in order to produce, by the energy beam, a component from the powder material located in the working region, and
a control device operatively connected to the beam-rotating device and to the scanner device, and configured to control the beam-rotating device and the scanner device, wherein
the control device is configured to correct a control of the scanner device according to a current angle of rotation of the beam-rotating device.

2. The manufacturing device according to claim 1, wherein the control device is configured to use a correction function dependent on the current angle of rotation of the beam-rotating device for correcting the control of the scanner device.

3. The manufacturing device according to claim 2, wherein the correction function additionally depends on a history of the control of the beam-rotating device and/or on a direction of rotation of the beam-rotating device, or wherein a function averaged over both directions of rotation of the beam-rotating device is used as the correction function.

4. The manufacturing device according to claim 1, wherein the beam-rotating device is configured to rotate the beam profile only in a predetermined direction of rotation.

5. A method for additive manufacturing of components from a powder material, the method comprising:
setting an angle of rotation of a beam profile around a beam axis of an energy beam, wherein the beam profile is not rotationally symmetrical about the beam axis,
moving the energy beam to a plurality of beam positions in a working region, so that the working region is locally selectively irradiated with the energy beam at the beam positions in order to produce, by the energy beam, a component from the powder material located in the working region, and
performing a correction of a control of the beam positions according to the angle of rotation.

6. The method according to claim 5, comprising assigning a correction vector, based on a correction function, to the beam positions according to the angle of rotation.

7. The method according to claim 6, comprising:
determining a deviation of an actual profile position of the beam profile from a target profile position of the beam profile on the working region, wherein the deviation is dependent on an angle of rotation of a beam-rotating device configured to rotate the beam profile of the energy beam about the beam axis, and
determining the correction function based on the deviation.

8. The method according to claim 7, comprising:
specifying a fixed beam position for the energy beam for a scanner device of a manufacturing device, wherein the fixed beam position determines the target profile position of the beam profile on the working region,
rotating the beam profile around the beam axis at the fixed beam position by using the beam-rotating device, and
determining the actual profile position of the beam profile on the working region according to the angle of rotation of the beam-rotating device.

9. The method according to claim 7, wherein the actual profile position of the beam profile is determined by using a sensor device located in the working region.

10. The method according to claim 9, comprising, before a first determination of the actual profile position, determining a relative position between a machine coordinate system of a manufacturing device predetermined by a scanner device and a sensor coordinate system of the sensor device.

11. The method according to claim 7, wherein the correction function is obtained by:
interpolation of the deviation, or
adaptation of an analytical function to the deviation, wherein the correction function is obtained as the adapted analytical function.

12. The method according to claim 7, wherein
a separate deviation is determined for each direction of rotation of the beam-rotating device, or
the beam-rotating device is rotated exclusively in a specific direction of rotation to determine the deviation.

13. The method according to claim 12, wherein a first deviation is determined for a first direction of rotation of the beam-rotating device, wherein a second deviation is determined for a second direction of rotation of the beam-rotating device which is different from the first direction of rotation, and
wherein the correction function is obtained by averaging the first deviation and the second deviation, or
wherein, as the correction function, a first correction function assigned to the first direction of rotation is obtained based on the first deviation, and a second correction function assigned to the second direction of rotation is obtained based on the second deviation.
